(19) United States
(12) Patent Application Publication
(10) Pub. No.: US 2006/0149468 A1
(43) Pub. Date: Jul. 6, 2006

(54) Navigation system

(75) Inventor: Shigehiro Muto, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/299,769

(22) Filed: Dec. 13, 2005

(30) Foreign Application Priority Data
Jan. 6, 2005 (JP) 2005-001919

(51) Int. Cl. G01C 21/32

(52) U.S. Cl. 701/211

(57) ABSTRACT

A navigation system comprising a position detector for locating a position of a vehicle in a route map, a map data storage for storing the route map with guidance setting for nodes in the route map, a route search function for searching and determining a proper route to a destination in the route map by using the guidance setting, a guidance providing function for providing route guidance based on the proper route determined by the route search function, and a guidance control function for controlling the guidance providing means according to the guidance setting. The guidance control function determines provision of an additional route guidance based on the guidance setting for a subject node in the proper route, and the guidance providing function provides the additional route guidance upon receiving instruction from the guidance control function.

### CROSS REFERENCE TO RELATED APPLICATION

This application is based on and claims the benefit of priority of Japanese Patent Application No. 2005-1919 filed on Jan. 6, 2005, the disclosure of which is incorporated herein by reference.

### FIELD OF THE INVENTION

The present invention generally relates to a navigation system.

### BACKGROUND OF THE INVENTION

In recent years, a navigation system in a vehicle provides a voice guidance when the vehicle reaches a guidance provision point of a guidance subject before actually reaching the guidance subject of the voice guidance such as an intersection or the like. The guidance provision point is generally determined based on a distance from the guidance subject. For example, the guidance provision points of an intersection are set at locations of 500 m, 300 m, and 100 m from the intersection. In addition, the intersections are categorized into two groups in terms of voice guidance setting, that is, the intersections with the voice guidance and the intersections without the voice guidance. FIG. 4 shows an intersection A with the guidance and an intersection B without the guidance for describing the situation. That is, the voice guidance setting for the intersection A provides the voice guidance because a vehicle approaching from the left can go straight through the intersection A or can turn to the left at the intersection A. On the other hand, the voice guidance setting for the intersection B does not provide the voice guidance because a vehicle approaching the intersection B from a point X can only turn to the right due to a one-way traffic from the left of the intersection B. Therefore, the navigation system provides the voice guidance “Turn left at 300 meters ahead” for the driver when the vehicle is located at the distance of 300 m from the intersection A as shown in FIG. 4.

However, the vehicle passes through the intersection B before it approaches the intersection A. In this case, the voice guidance that is intended to guide the driver to the left at the intersection A may be mistakenly understood for the voice guidance at the intersection B. That is, the driver of the vehicle has to cope with a situation that the voice guidance provided by the navigation system is not appropriate for an actual traffic regulation. This may cause an inconvenience for the driver because the vehicle can not turn to the left at the intersection B.

### SUMMARY OF THE INVENTION

In view of the above-described and other problems, the present invention provides a navigation system that suitably provides a route guidance for a driver of a vehicle when a subject node for route guidance in a route map is closely located to other node.

The navigation system of the present invention includes a position detector for locating a position of the vehicle in the route map, a map data storage for storing the route map with guidance setting for nodes in the route map including intersections, a route search function for searching a proper route to a destination, a route guidance function for providing route guidance based on the proper route determined by the route search function, a guidance control function for controlling the route guidance according to the situation of the proper route to the destination. The guidance control function determines provision of an additional route guidance based on the guidance setting for a subject node in the proper route, and the guidance providing function provides the additional route guidance upon receiving instruction from the guidance control function.

The navigation system of the present invention provides the additional route guidance on condition that (1) there are one or more extra nodes without guidance provision in a section of the proper route from a guidance provision point of the subject node to the subject node and, (2) turn directions at the extra nodes from the guidance provision point to the subject node are different from the route guidance for the subject node. That is, the route guidance in a guidance provision section, i.e., a section in the proper route from the guidance provision point of the subject node to the subject node itself, is determined by the guidance control function. In this manner, the driver of the vehicle can appropriately understand the turn directions at the extra nodes in the section of the proper route from the guidance provision point of the subject node to the subject node when the extra nodes do not have the guidance provision.

Further, the navigation system of the present invention includes a node finding function for finding an extra node in the guidance provision section. Furthermore, the navigation system of the present invention provides the route guidance in a form of voice guidance for the driver of the vehicle.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a navigation system in an embodiment of the present invention;

FIG. 2 shows a flowchart of route search process in the embodiment;

FIG. 3 shows a flowchart of a route guidance process in the embodiment;

FIG. 4 shows an illustration of a voice guidance provision by a prior art; and

FIG. 5 shows an illustration of a voice guidance provided by the navigation system of the present invention.

### DETAILED DESCRIPTION OF THE PREFERRED EMBODIMENTS

An embodiment of the present invention is described with reference to the drawings. A navigation system 100 of the present invention is intended for use in a vehicle such as an automobile or the like.

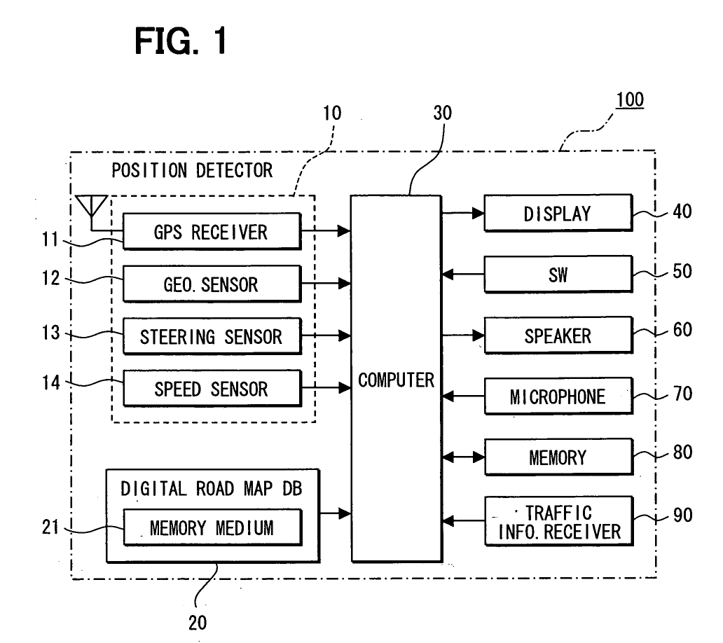

FIG. 1 shows a block diagram of the navigation system 100 in an embodiment of the present invention.

The navigation system 100 includes a position detector 10, a digital road map database 20, a computer 30, a display device 40, operation switches 50, a speaker 60, a microphone 70, an external memory 80, and a traffic information receiver 90.

The computer 30 includes a CPU, a ROM, a RAM, an I/O of well-known type as well as a bus line that connects these parts. The ROM stores a program that is executed in the computer 30, and the CPU and/or other parts execute processing for computing.

The position detector 10 includes a GPS receiver 11, a geomagnetism sensor 12, and a steering sensor 13 for determining a position and a direction of the vehicle. The position detector 10 further includes a speed sensor for determining a traveling distance based on a speed of the vehicle. The position and/or direction of the vehicle may be determined based on data received by a traffic information receiver 90, or may be determined based on data generated by, for example, a gyro-sensor, a wheel sensor or the like.

The digital road map database 20 includes link data, node data, intersection data, background data, text data and the like. The data in the database 20 is provided for the computer 30 for calculation of a route to a destination or the like. The database 20 includes information storage medium 21 such as a CD-ROM, a DVD-ROM, a memory card, a hard disk drive or the like.

Link data in the database 20 is a connection between nodes that are defined at a crossing/dividing/merging point of two or more roads in a road map. The link data includes a link ID, a link length, coordinates for start/end nodes (e.g., longitude/latitude), a road name, a road type, a road width, a number of lanes, a speed limit and the like.

Node data in the database 20 is a connection point of two or more links in the road map. The node data includes a node ID, node coordinates, a node name, a connecting link ID, a node type (intersection type), guidance provision and the like. The guidance provision defines whether voice guidance for turning at the intersection is provided or not. The link data together with the node data represents the road in the road map.

Intersections in the road map of the present embodiment are defined by the intersection type and a no-guidance flag in the node data. The no-guidance flag is used to mark an intersection that has no route guidance. That is, the value of the no-guidance flag is “1” when the route guidance is not required for the intersection, and the value is “0” when the route guidance is required. For example, the route guidance for a calculated route is not required for an intersection C shown in FIG. 5 because the road from the left toward the intersection C is a one way road.

The background data in the database 20 is used to describe facilities, topography and the like around the road in the road map that are displayed on the display device 40. The text data is used to display a place name, a facility name, a road name and the like at a relevant position in the road map.

The display device 40 is used to display the position of the vehicle, the road map and the like based on the data in the database 20. The route guidance (guidance line on the road) from a current position to a destination is also displayed in the road map when the destination is specified. The display device 40 is a display device of well-known type such as, for example, a liquid crystal display or the like.

The operation switches 50 is used to input various information. The operation switches 50 may be, for example, a touch panel switch or a mechanical switch disposed on the display device 40.

The speaker 60 is used to provide the voice guidance for the driver of the vehicle. The voice guidance is provided when the vehicle reaches a guidance provision point of a subject node. The guidance provision points are, for example, located at the distances of 700 m, 300 m, and 100 m from the subject node.

The microphone 70 is used to input driver's voice for the computer 30. The computer 30 analyzes and interprets the driver's voice for executing various types of processing.

The external memory 80 includes memory media such as a memory card, a hard disk drive or the like. The external memory 80 stores various types of data such as text data, image data, voice data or the like prepared by a user.

The traffic information receiver 90 receives traffic information provided by traffic information center or the like. The traffic information receiver 90 may be used to transmit information from the vehicle to the information center. The received traffic information is processed and displayed on the display device 40 together with the road map.

The navigation system 100 of the present invention calculates an optimally proper route to a destination that is specified by, for example, the driver of the vehicle, and displays the calculated route on the road map. The proper route to the destination is calculated by using Dijkstra method or the like. The destination may be identified by inputting an address, a name, a telephone number or the like.

The functions of the navigation system 100 described above are mainly provided by the computer 30. That is, the computer 30 calculates and displays the proper route upon receiving an input of the destination based on the road map stored in the database 20. The computer 30 also calculates and displays a current vehicle position and a differently scaled road map on the display device 40.

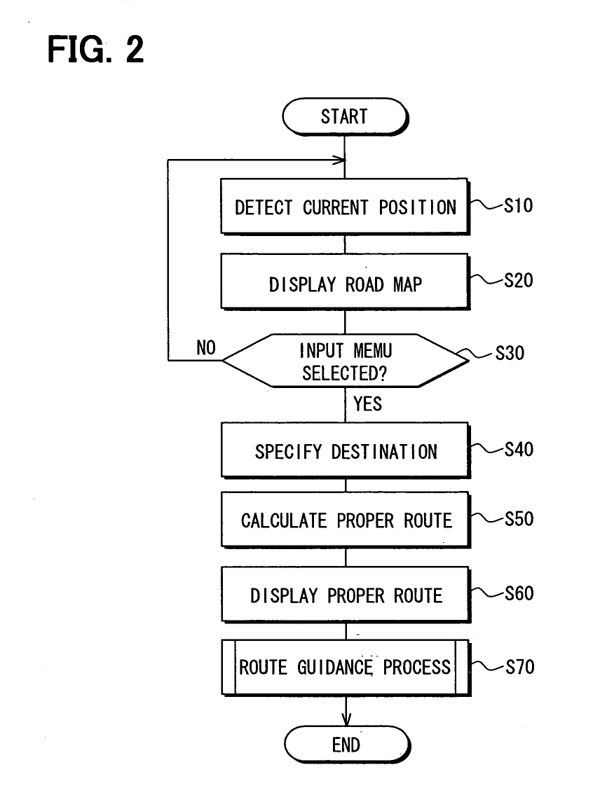

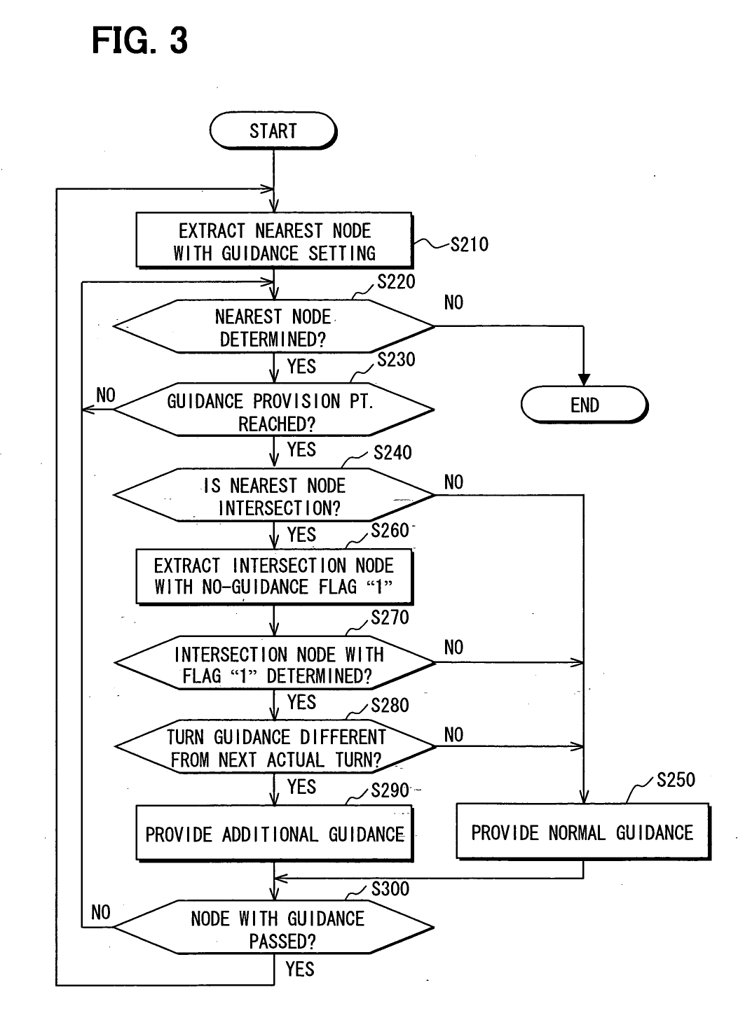

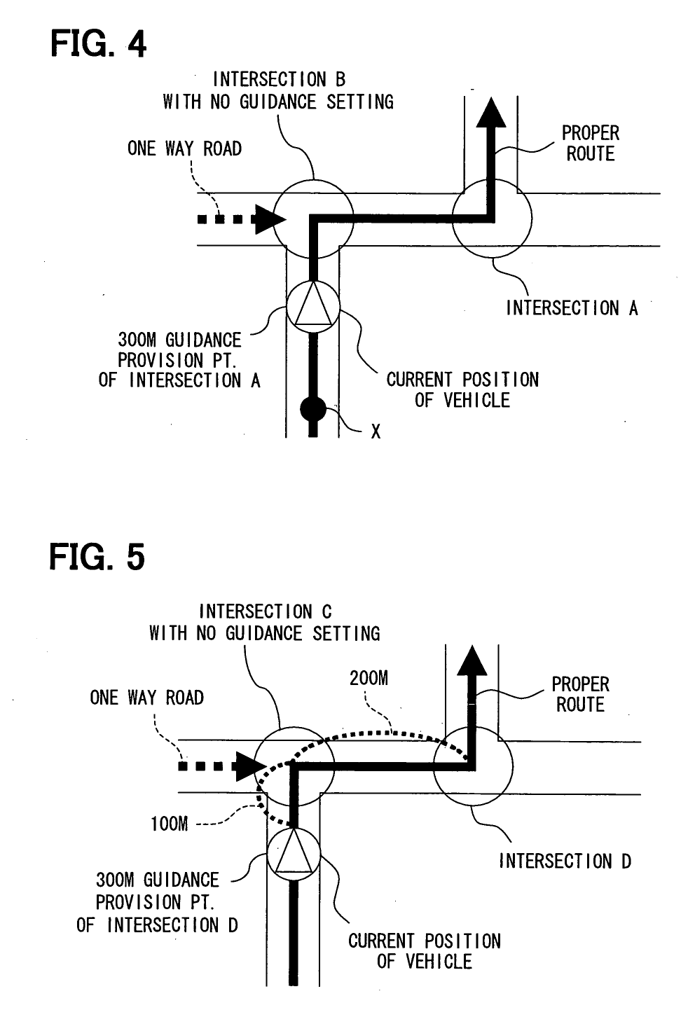

The processes for determining the proper route and for providing the route guidance are described with reference to the flowcharts in FIGS. 2 and 3. That is, FIG. 2 shows a flowchart of route search process in the present embodiment, and FIG. 3 shows a flowchart of a route guidance process in the present embodiment.

In step S10 in FIG. 2, a current position of the vehicle is detected. The current position is basically calculated by incrementally integrating the speed and the direction to the previous position based on the data derived from the geomagnetism sensor 12, the steering sensor 13, and the speed sensor 14. In addition, the GPS receiver provides coordinates of the current position in the same format as the coordinates of the nodes and links (longitude and latitude) for comparison. The calculation of the current position is compensated by using the GPS data.

In step S20, the display device 40 displays the current position of the vehicle on the road map that is retrieved from the digital map database 20.

In step S30, the process determines whether the input menu is selected. More practically, the process determines whether an item “destination menu” in a menu dialog box is selected. The process proceeds to step S40 when it determines the “destination menu” is selected, and the process goes back to step S10 when the “destination menu” is not selected.

In step S40, the destination is selected and specified. More practically, the user uses destination search items such as “name search,” “facility type search,” “telephone number search,” or the like. The destination is selected based on an input for, for example, the telephone number search.” The destination is selected and specified based on the telephone number that is correlated with a destination.

In step S50, a proper route from the current position to the destination is calculated by using Dijkstra method or the like.

In step S60, the proper route calculated in step S50 is displayed. More practically, the proper route is represented by using a figure such as an emphasized line in the road map on the display device 40.

In step S70, a route guidance process is executed.

Voice guidance in the route guidance process is explained in the flowchart in FIG. 3.

In step S210, the process extracts a nearest node with guidance setting from the current position in a portion of the proper route to be traveled.

In step S220, the process determines whether the nearest node with the guidance setting is identified. The process proceeds to step S230 when the nearest node with the guidance setting is identified. The process concludes when the nearest node is not identified.

In step S230, the process determines whether the vehicle reaches a guidance provision point of the guidance setting extracted in step S220. The process repeats step S230 until the vehicle reaches to the guidance provision point when the process determines that the guidance provision point is not yet reached. The process proceeds to step S240 when the guidance provision point is determined to be reached.

In step S240, the process determines whether the node is an intersection with a no-guidance flag “0” in the guidance setting. The process proceeds to step S250 when the node is not an intersection.

In step S250, the voice guidance is provided. More practically, the voice guidance for, for example, a ramp of a toll road “Ramp of toll road, 300 meter ahead” is provided from the speaker 60 when the vehicle reaches 300 m guidance provision point from the node.

The process proceeds to step S260 when the node is determined to be an intersection with no-guidance flag “0” in the guidance setting in step S240.

In step S260, the process extracts a node that represents an intersection having the no-guidance flag “1” in the guidance setting in a portion of the proper route from the current position to the node that is identified in step S220.

In step S270, the process determines whether the node of the intersection with the no-guidance flag “1” in the guidance setting is extracted. The process proceeds to step S250 when the intersection node with the no-guidance flag “1” is not extracted. The process proceeds to step S280 when the intersection node with the no-guidance flag “1” is extracted.

In step S280, the process determines whether a turn at the intersection node with no-guidance flag “1” and a turn at the node determined in step S220 are in the same direction in the proper route of guidance. The process proceeds to step S250 when the two turns are determined to be in the same direction. The process proceeds to step S260 when the two turns are in different directions.

In step S290, an additional voice guidance is provided. That is, the additional voice guidance is provided for the intersection node that has the guidance setting with the no-guidance flag “1.” An illustration for this situation is shown in FIG. 5. The additional voice guidance is provided when the vehicle approaching an intersection C that has the guidance setting with the no-guidance flag “1” passes the 300 m guidance provision point of an intersection D. The voice guidance from the speaker 60 in this situation is, for example, “Turn right at next intersection, then turn left at the intersection in 200 meters.” In this manner, the driver of the vehicle is safely guided by the voice guidance for traveling on the proper route even when an originally no-guidance intersection exists in a portion of the proper route between the guidance provision point of an intersection ahead of the no-guidance intersection.

In step S300, the process determines whether the vehicle passes the node with the guidance setting. The process proceeds to step S210 when the node with the guidance setting identified in step S220 is determined to be passed. The process goes back to step S230 when the node is determined to be not yet passed.

Although the present invention has been fully described in connection with the preferred embodiment thereof with reference to the accompanying drawings, it is to be noted that various changes and modifications will become apparent to those skilled in the art.

For example, the additional voice guidance in the above-described embodiment may be provided in a different manner. That is, the voice guidance for the intersection with no-guidance setting flag “1” (i.e., the intersection C) and the voice guidance for the intersection with the guidance setting (i.e., the intersection D) may be separately provided at different points in the proper route.

Such changes and modifications are to be understood as being within the scope of the present invention as defined by the appended claims.

What is claimed is:

1. A navigation system comprising:
a position detector for locating a position of a vehicle in a route map;
a map data storage for storing guidance setting for nodes in the route map;
a route search means for searching and determining a proper route to a destination in the route map;
a guidance providing means for providing route guidance based on the proper route determined by the route search means; and
a guidance control means for controlling the guidance providing means according to the guidance setting,
wherein the guidance control means determines provision of an additional route guidance based on the guidance setting for a subject node in the proper route, and
the guidance providing means provides the additional route guidance upon receiving instruction from the guidance control means.

2. The navigation system according to claim 1 further comprising:
a node finding means for finding an extra node with the guidance setting of no guidance provision in a section of the proper route between a guidance provision point of the subject node and the subject node,
wherein the guidance control means identify a turn guidance of the proper route at the extra node that exists in the section of the proper route between the guidance provision point of the subject node and the subject node, and
the guidance control means determines the provision of the additional route guidance when the turn guidance at the extra node in the section of the proper route is different from the turn guidance at the subject node.

3. The navigation system according to claim 2,
wherein the route guidance is provided in a form of audible signal.
